(19) United States
(12) Patent Application Publication
(10) Pub. No.: US 2020/0311749 A1
(43) Pub. Date: Oct. 1, 2020

(54) System for Generating and Using a Stacked Prediction Model to Forecast Market Behavior

(71) Applicant: Dell Products L.P., Round Rock, TX (US)

(72) Inventors: Prakash Sridharan, Bangalore (IN); Rajkumar Dan, Bangalore (IN)

(73) Assignee: Dell Products L.P., Round Rock, TX (US)

(21) Appl. No.: 16/366,302

(22) Filed: Mar. 27, 2019

(51) Int. Cl. G06Q 30/02; G06N 5/04

(52) U.S. Cl. CPC G06Q 30/0202; G06N 20/00; G06N 5/04

(57) ABSTRACT

A method, system and computer-usable medium are disclosed for generating a stacked prediction model and using the stacked prediction model to forecast market behavior. One embodiment is directed to a computer-implemented method for forecasting market behavior comprising: accessing stored time-series sequenced data representing historical market behavior; applying multiple prediction models to the time-series sequenced data; determining a respective error associated with application of each multiple prediction model to the time-series sequenced data; generating a stacked prediction model using at least two of the multiple prediction models, wherein the stacked prediction model includes a weighting factor for each of the prediction models used in the stacked prediction model, wherein the weighting factor for each of the prediction models in the stacked prediction model employs an inversion of the respective error in the prediction model; and applying the stacked prediction model to forecast market behavior.

### BACKGROUND OF THE INVENTION

### Field of the Invention

The present invention relates to information handling systems. More specifically, embodiments of the invention relate to generating and using a stacked prediction model to forecast market behavior.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One of the uses of such information systems include forecasting market behavior. Information systems used in forecasting market behavior are often complex and difficult to implement, typically involving processing large amounts of data. Given the large amount of data and the resources needed to process that data, it may be difficult to forecast market behavior with the desired degree of accuracy.

### SUMMARY OF THE INVENTION

A system of one or more computers can be configured to perform particular operations or actions by virtue of having software, firmware, hardware, or a combination of them installed on the system that in operation causes or cause the system to perform market forecasts using a stacked prediction model. One or more computer programs can be configured to perform particular operations or actions by virtue of including instructions that, when executed by data processing apparatus, cause the apparatus to generate the stacked prediction model and execute market forecasts using the model. One embodiment is directed to a computer-implemented method for forecasting market behavior including: accessing stored time-series sequenced data representing historical market behavior; applying multiple prediction models to the time-series sequenced data; determining a respective error associated with application of each multiple prediction model to the time-series sequenced data; generating a stacked prediction model using at least two of the multiple prediction models, where the stacked prediction model includes a weighting factor for each of the prediction models used in the stacked prediction model, where the weighting factor for each of the prediction models in the stacked prediction model employs an inversion of the respective error in the prediction model; and applying the stacked prediction model to forecast market behavior. Other embodiments of this aspect include corresponding computer systems, apparatus, and computer programs recorded on one or more computer storage devices, each configured to perform the actions of the methods.

Another embodiment is directed to a system including: a processor; a data bus coupled to the processor; and a non-transitory, computer-readable storage medium embodying computer program code, the non-transitory, computer-readable storage medium being coupled to the data bus, the computer program code interacting with a plurality of computer operations and including instructions executable by the processor and configured for: accessing stored time-series sequenced data representing historical market behavior; applying multiple prediction models to the time-series sequenced data; determining a respective error associated with application of each multiple prediction model to the time-series sequenced data; generating a stacked prediction model using at least two of the multiple prediction models, where the stacked prediction model includes a weighting factor for each of the prediction models used in the stacked prediction model, where the weighting factor for each of the prediction models in the stacked prediction model employs an inversion of the respective error in the prediction model; and applying the stacked prediction model to forecast market behavior. Other embodiments of this aspect include corresponding computer systems, apparatus, and computer programs recorded on one or more computer storage devices, each configured to perform the actions of the methods.

Another embodiment is directed to a non-transitory, computer-readable storage medium embodying computer program code, the computer program code including computer executable instructions configured for: accessing stored time-series sequenced data representing historical market behavior; applying multiple prediction models to the time-series sequenced data; determining a respective error associated with application of each multiple prediction model to the time-series sequenced data; generating a stacked prediction model using at least two of the multiple prediction models, where the stacked prediction model includes a weighting factor for each of the prediction models used in the stacked prediction model, where the weighting factor for each of the prediction models in the stacked prediction model employs an inversion of the respective error in the prediction model; and applying the stacked prediction model to forecast market behavior. Other embodiments of this aspect include corresponding computer systems, apparatus, and computer programs recorded on one or more computer storage devices, each configured to perform the actions of the methods.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 is a block diagram of a market forecast environment in which certain embodiments of the disclosed marketing system may be employed;

FIG. 3 shows a simplified bock diagram depicting the flow of information that may be used in certain embodiments of the market forecast system to perform market behavior forecasting;

FIG. 4 is a flowchart depicting operations that may be executed in certain embodiments of a market forecast system;

FIG. 5 is a graph showing one example of time-series sequenced data that may be consumed by the stacked prediction model generator to generate a stacked prediction model;

FIG. 6 is a graph showing one example of a cross-correlation between a variable of interest and a predictor;

FIG. 7 is a chart showing examples of errors that may be associated with different prediction models in certain embodiments of the disclosed system;

FIG. 8 is a flowchart depicting operations that may be executed in certain embodiments of the market forecast system; and

FIG. 9 depicts one example of a user interface 902 that may be implemented in certain embodiments of the disclosed system.

### DETAILED DESCRIPTION

A system, method, and computer-readable medium are disclosed for using machine learning to improve forecasting of market behavior. Certain aspects of the invention reflect an appreciation that is common for many organizations to employ various forecasting approaches in an attempt to cope with the uncertainty of the future. Likewise, various aspects of the invention reflect an appreciation that while certain forecasting approaches may inherently be based upon qualitative experience, knowledge and judgment, their accuracy typically involves some degree of quantitative, statistical, and predictive analysis. Certain aspects of the invention recognize that there are a substantial number of different types of quantitative, statistical, and predictive analyses that may be applied to historical data in order to predict future market behavior. Such analyses may include application of predictive models to historical data.

Certain aspects of the invention recognize that a model that is optimal in one use case is not necessarily optimal in other use cases. Certain aspects of the invention recognize that sales support and supply chain teams in an organization, particularly world-wide organizations, face the challenge of working with forecasts from multiple sources. In certain instances, these sources are not necessarily built based on mathematically sound techniques but, rather, are based on business intuition and heavily dependent on human intervention. In certain instances, this leads to erroneous expectations from the field impacting the handling of the supply chain. Sales teams, in certain instances, also face the risk of sudden shocks within the system leading to spiraling impact on teams working across the product and order cycle. Certain aspects of the invention are directed to generating a robust model capable of producing greater forecast accuracy and reliability with a reduced need of user intervention.

Certain aspects of the invention also recognize that an organization often engages with a substantial number of resellers to sell its products. As an example, in the consumer space, forecasts are currently done by resellers based on their own internal data as opposed to knowledge gained from resources of the organization. Since such forecasts often solely involve the reseller, the organization cannot evaluate the market behavior forecasting techniques deployed by the resellers, nor the type of data used to build the reseller's forecasts. This makes it difficult for the organization to make product related decisions such as promotion planning, inventory planning and pricing. Certain aspects of the invention recognize that the organization may have a plethora of information mined regarding reseller performance and product sales, which can be used to replace and/or supplement the data provided by the reseller. Additionally, certain aspects of the invention recognize that the organization may generate a more reliable prediction model based on its own internal data relating to reseller needs and performance. Such reliable reseller market predictions may assist the organization in organizing its factory production and/or product inventory.

Certain aspects of the invention also recognize that in organization often actively works with its original equipment manufacturers (OEMs) to source many components which go in to building the organization's products. In certain instances, the OEMs may request the organization to provide a prediction of expected sales related to the OEM's products. As an example, in the computer marketplace, OEMs may request predictions as to the number of processors, number of memory chips, number of disk drive devices, etc., they will have to provide to the organization to meet the organization's demands. In certain instances, product managers are left in a situation where they need to estimate such numbers relying on multiple data sources which are not necessarily accurate. Certain embodiments of the invention provide an accurate prediction model to provide such information to OEMs thereby allowing the OEMs to efficiently use their resources to provide the necessary supply of components to the organization.

Certain embodiments of the invention recognize that one shortcoming of the foregoing forecasting methods is that they are typically directed to a one size fits all approach employing only a single deterministic manipulation technique to arrive at forecasts. Certain embodiments of the invention recognize that this may lead to errors if the underlying prediction models are not tested and optimized for a particular use case. Certain embodiments of the invention recognize that the underlying model may need to be changed over time. Certain embodiments recognize that a change in the underlying module often requires manual step by step approach to improve forecast accuracies. In certain instances, only the underlying model with the lowest error rate as defined by the user is used for forecasting.

Certain embodiments of the invention recognize that the model chosen by the user might have a low error rate, but may ignore the benefits provided by other models. As an example, the chosen model may have a low error rate over short durations of time but may have been increased error rate over longer stretches of time.

To address shortcomings of current prediction models, certain embodiments of the present invention recognize that a stacked prediction model may be generated from multiple prediction models. In certain embodiments, multiple prediction models are applied to time-series sequenced data representing market behavior for an item of interest. In certain embodiments, the item of interest may be the sales, purchases, production data, etc. of a product or service. Certain embodiments involve determining the error associated with the application of the multiple prediction models to the time-series sequenced data. In certain embodiments, a stacked prediction model is generated. In certain embodiments, the stacked prediction model uses at least two of the multiple prediction models, which includes a weighting factor for each of the prediction models used in the stacked prediction model. In certain embodiments, the weighting factor for each of the prediction models in the stacked prediction model employs an inversion of the respective error in the prediction model. In certain embodiments, the stacked prediction model is used to forecast market behavior, consolidating the benefits associated with multiple prediction models while ensuring that prediction models of the stack having lower error rates are given a higher weighting than prediction models of the stack having higher error rates. In certain embodiments, the stacked prediction model is more capable of accurately predicting market behavior than a single deterministic model. In certain embodiments, the stacked prediction model may be automatically reevaluated in response to changes in the error in the stacked prediction model over time.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

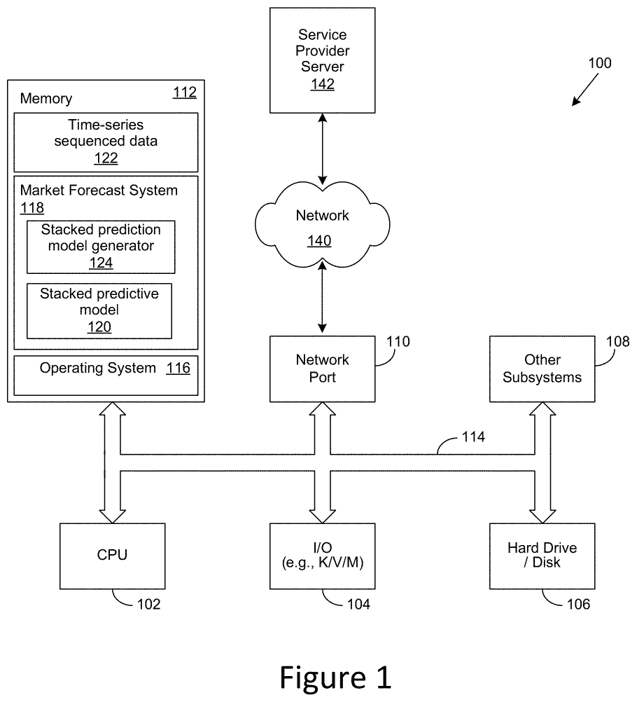

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a market forecast system 118. In certain embodiments, the market forecast system 118 may include a stacked prediction model 120 that is used to make market forecasts. In one embodiment, the information handling system 100 is able to download the market forecast system 118 from the service provider server 142. In another embodiment, the market forecast system 118 is provided as a service from the service provider server 142.

The market forecast system 118 performs a market forecasting operation. In certain embodiments, the market forecast system 118 forecasts market behavior using the stacked prediction model 120, as described herein. In certain embodiments, the stacked prediction model 120 is generated by a stacked prediction model generator 124 using time-series sequenced data 122, described herein. As used herein, a stacked prediction model 120 is a prediction model that uses multiple, individual prediction models that are each weighted within the stacked prediction model based on the performance error respectively associated with each of the multiple, individual prediction models.

The market forecast system 118 and corresponding stacked prediction model 120 operate to improve processor efficiency, and thus the efficiency of the information handling system 100, facilitating the forecasting of a market's behavior. In certain embodiments, the market behavior forecasting operation can be performed during operation of an information handling system 100. As will be appreciated, once the information handling system 100 is configured to perform the market behavior forecasting operation using the stacked prediction model 120, the information handling system 100 becomes a specialized computing device specifically configured to perform the market behavior forecasting operation and is not a general purpose computing device. Moreover, the implementation of the market behavior forecasting operation using the stacked prediction model on the information handling system 100 improves the functionality of the information handling system 100 and provides a useful and concrete result of forecasting the behavior of a market. In certain embodiments, the performance of the market behavior forecasting operation results in the realization of a more accurate market forecast which can result in tangible benefits associated with physical inventory, optimized use of production line equipment and resources, etc.

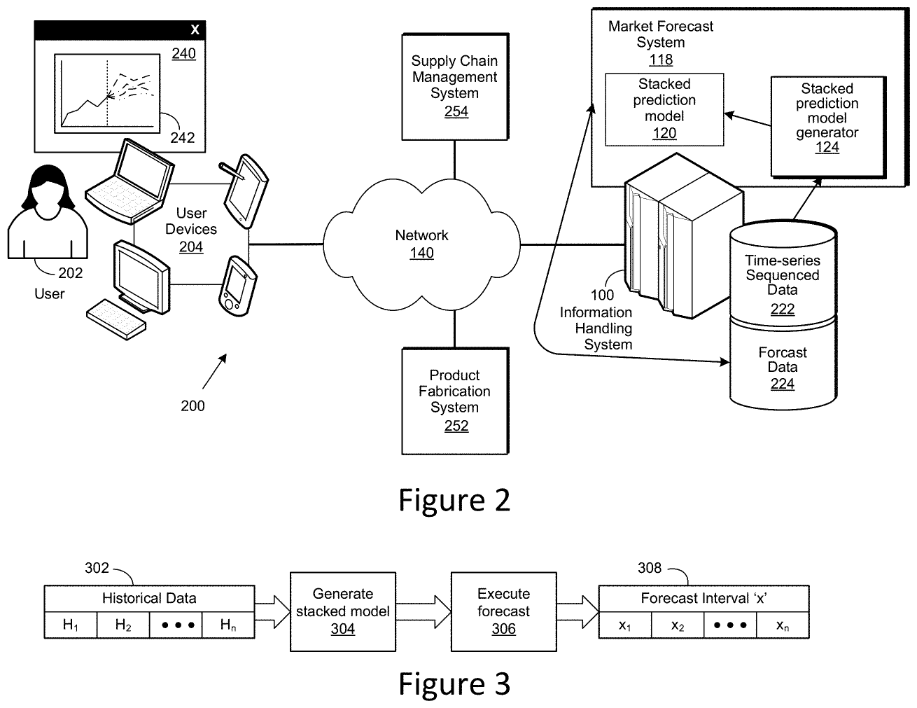

FIG. 2 is a block diagram of a market forecast environment 200 in which certain embodiments of the invention may be employed. In certain embodiments, the market forecast environment 200 may include a market forecast system 118 and associated stacked prediction model 120. In certain embodiments, the market forecast environment 200 may include a repository of time-sequenced historical market data 222 that is accessed by the stacked prediction model generator 124 to generate the stacked prediction model 120. In certain embodiments, the repository of time-sequenced historical market data 222 may include information regarding the volume of sales of one or more products over a historical timeframe. In certain embodiments, the time-sequenced data 222 may be derived from a source internal to the organization. In certain embodiments, the time-sequenced data 222 may be obtained from an external source, such as an OEM, reseller, etc. In certain embodiments, the time-sequenced data 222 may be obtained from a technical support call center representing the number of calls arriving at specific time intervals. It will be recognized by those skilled in the art, in view of the teachings of the present disclosure, that various time-series sequenced data may include any data representative of a market parameter that can be sequenced as time-series sequenced data for ingestion by the stacked prediction model generator 124.

In certain embodiments, a user 202 may use a user device 204 to interact with the market forecast system 118. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a market forecast system user interface (UI) 240. In certain embodiments, the market forecast system UI 240 may be implemented to present a graphical representation 242 of market behavior forecast information, which is automatically generated in response to interaction with the market forecast system 118. In certain embodiments, the user 202 may be involved in certain activities including, without limitation, support and supply chain teams, reseller forecasting, OEM forecasting, etc.

In certain embodiments, the user device 204 is used to exchange information between the user 202 and the market forecast system 118, a product fabrication system 252, and a supply chain management system 254 over a network 140. In certain embodiments, the network 140 may be a public network, such as a public internet protocol (IP) network, a physical private network, a wireless network, a virtual private network (VPN), or any combination thereof. Skilled practitioners of the art will recognize that many such embodiments are possible and the foregoing is not intended to limit the spirit, scope or intent of the invention.

In certain embodiments, the market forecast system UI 240 may be presented via a website. For the purposes of this disclosure a website may be defined as a collection of related web pages which are identified with a common domain name and is published on at least one web server. A website may be accessible via a public IP network or a private local network.

A web page is a document that is accessible via a browser, which displays the web page via a display device of an information handling system. In certain embodiments, the web page also includes the file which causes the document to be presented via the browser. In certain embodiments, the web page may comprise a static web page, which is delivered exactly as stored, and a dynamic web page, which is generated by a web application that is driven by software that enhances the web page via user input to a web server.

In certain embodiments, the market forecast system 118 may be implemented to interact with the product fabrication system 252, which in turn may be executing on a separate information handling system. In various embodiments, the product fabrication system 252 interacts with a supply chain management system 254. In certain embodiments, the product fabrication system 252 fabricates products, which may result in the need to have accurate market behavior forecasts for the products it may fabricate. In certain embodiments, the market forecast system 118 may be implemented to perform a market behavior forecast function, which facilitates the operation of the supply chain management system 254. In certain embodiments, the facilitation of the operation of the supply chain management system 254 may result in more efficient and cost-effective operation of the product fabrication system 252.

FIG. 3 shows a simplified bock diagram depicting the flow of information that may be used in certain embodiments of the market forecast system 118 to perform market behavior forecasting. As used herein, a market broadly refers to various systems, institutions, procedures, social relations, and infrastructures where forces of supply and demand operate. In general, markets are where buyers and sellers interact, directly or through intermediaries, to trade goods, services, and contracts or other instruments, for money or barter. Markets also provide various mechanisms for determining the price of an item, communicating its price information, facilitating a transaction associated with the item, and effecting its distribution. In practice, the market for a particular item is made up of existing and potential buyers who need it and have the ability and willingness to pay for it.

As likewise used herein, market behavior broadly refers to selling and buying trends exhibited by organizations, businesses, and individual consumers within a particular market or market segment. Certain embodiments of the invention reflect an appreciation that analysis of such behavioral trends is often used to devise various strategies intended to boost sales, provide information to an external organizations, such as OEMs, resellers, customers, etc. Forecasting, as likewise used herein, broadly refers to the process of making predictions of the future based upon past and present data, and commonly, by analysis of certain trends. Likewise, as it relates to market behavior, forecasting broadly refers to various approaches that use historical data as inputs to make informed estimates that are predictive in the determining the direction of future market trends. Certain embodiments of the invention reflect an appreciation that market trends may indicate demand, or lack thereof, for various goods and services. Certain embodiments of the invention likewise reflect an appreciation that organizations often utilize market behavior forecasting to project demand for the goods and services they offer and allocate their budgets, resources, and production accordingly.

In certain embodiments, historical data 302 relating to a market behavior over a timeframe is accessed to generate a stacked prediction model at operation 304, described in further detail herein. In certain embodiments, the market forecast system 118 uses the stacked prediction model at operation 306 to execute a market forecast operation resulting in forecasted market behavior data 308 over a forecast interval. In certain embodiments, the user 202 may interact with the market forecast system 118 through the UI 240 in order to identify a variable of interest and corresponding predictor that is to be used to generate the market behavior data 308. As used herein, a variable of interest corresponds to the data which is the subject of the market behavior data that is to be forecast, while the predictor is used as the input to the stacked prediction model to generate the data for the variable of interest. As an example, the user 202 may identify “product volume sales” as the variable of interest, and forecast interval as the predictor or Holiday Events as predictors. Predictors can also be variables like customer demographics, product lifecycle events etc. Another example is the user 202 identifying “processor volume” as a variable of interest and potential predictors can be computing platform volumes related to platforms where the processor can fit in.

In certain embodiments, the market behavior forecasting operation may be related to forecasting the behavior of a certain market, or market segment, for a particular forecasting interval selected by the user 202. As used herein, a forecasting interval 304 broadly refers to a time interval for which the market forecast system 118 is directed to generate a market forecast. In certain embodiments, the time units used to measure a forecasting interval may include calendar quarters, months, weeks, days, hours, or minutes. In certain embodiments, the forecasting interval may be continuous. In certain embodiments, multiple, non-contiguous forecasting intervals may be used as the predictor.

Certain embodiments of the invention reflect an appreciation that it is often advantageous for various organizations to identify and measure seasonal variations within their market to help them plan for the future. Various embodiments of the invention likewise reflect an appreciation that such planning may allow an organization to prepare for temporary increases or decreases in labor requirements and inventory as demand for their product or service fluctuates over certain periods. Likewise, certain embodiments of the invention reflect an appreciation that seasonality may be caused by various factors, such as market forces, the health, or lack thereof, of financial markets, geopolitical dynamics, such as increases or decreases in Gross Domestic Product (GDP), advances in technology and so forth.

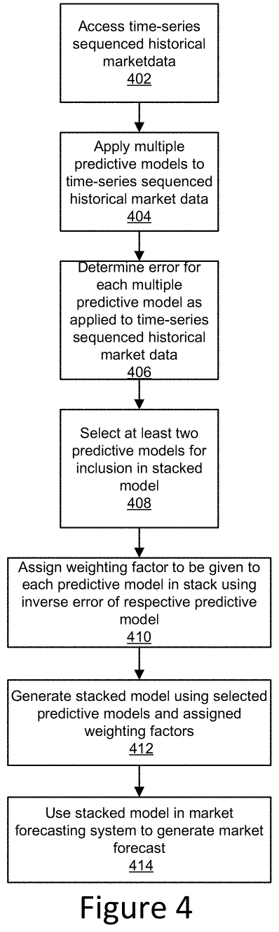

FIG. 4 is a flowchart depicting operations that may be executed in certain embodiments of the market forecast system 118. Generally stated, the depicted operations include the generation of the stacked prediction model and its application to generate a market forecast. In certain embodiments, the market forecast system 118 accesses time-series sequenced data at operation 402. At operation 404, certain embodiments apply the time-series sequenced data individually to multiple prediction models and determine the error for each at operation 406. It will be recognized, in view of the teachings of the present disclosure, that the prediction models may include: Bagged ETS, BATS, double exponential smoothing, exponential smoothing, ARIMA, SARIMA, SARIMAX, neural learning, etc. As used herein, exponential and double exponential smoothing refer to models in which the time-series sequenced data is smoothed using an exponential window function. As used herein, ARIMA refers to an Autoregressive Integrated Moving Average model that is used as a forecasting method for univariate time series data and supports both autoregressive and moving average elements. As used herein, SARIMA and SARIMAX are Seasonal Autoregressive Integrated Moving Average models, and are extensions of ARIMA that explicitly support univariate time series data with a seasonal component (e.g., time-series sequenced data that has a repetitive component). The SARIMAX model also incorporates a predictor which varies over time like the variable of interest. The exponential smoothing and double exponential smoothing techniques use the time series data to arrive at exponential functions assigning exponentially decreasing weights over time to make forecasts. The Bagged ETS model uses bootstrapped sampling within the time series to arrive at forecasts. BATS model applies Box-Cox transformation in addition to ARMA model for the time series to arrive at forecasts. The neural network model is a single layer feedforward model built on lagged inputs from the variable of interest and predictors to arrive at forecasts.

In certain embodiments, the error associated with each prediction model as applied to the time-series sequenced data is determined at operation 406. In certain embodiments, the error associated with the prediction model indicates a relationship between a value that is forecast by the prediction model and the actual observed data. The error may be determined in certain embodiments using various algorithms such as a root-mean-square deviation (RMSD) or roots-mean-square error. As used herein, the root-mean-square deviation (RMSD) or root-mean-square error (RMSE) is an algorithm used to measure of differences between values (sample or population values) predicted by a model or an estimator and the values observed. The RMSD represents the square root of the second sample moment of the differences between predicted values and observed values or the quadratic mean of these differences. These deviations are called residuals when the calculations are performed over the data sample that was used for estimation and are called errors (or prediction errors) when computed out-of-sample. The RMSD serves to aggregate the magnitudes of the errors in predictions for various times into a single measure of prediction power. RMSD is a measure of accuracy, to compare forecasting errors of different models for a particular dataset and not between datasets, as it is scale-dependent.

In certain embodiments, the error associated with a prediction model may be determined using a mean absolute percentage error (MAPE) algorithm. As used herein, the mean absolute percentage error (MAPE), also known as mean absolute percentage deviation (MAPD), is a measure of prediction accuracy of a forecasting method in statistics, for example in trend estimation, also used as a Loss function for regression problems in Machine Learning. In certain embodiments, the MAPE is determined as:

$$M A P E = \frac{1}{n} {\sum }_{t = 1}^{n} \vert \frac{{A}_{t} - {F}_{t}}{{A}_{t}} \vert ,$$

where At is the actual observed value, Ft is the value forecasted by the prediction model, and n is number of values in the time-series sequenced data.

In certain embodiments, at least two prediction models are selected for inclusion in the stacked prediction model at operation 408. In certain embodiments, more than two prediction models may be included in the stacked prediction model. In certain embodiments, the determination as to which prediction models are included in the stacked prediction model may be determined based on the error associated with each prediction model, where only prediction models having errors below a certain level are included in the stacked prediction model. In certain embodiments, the error associated with the prediction model may be presented to a user, who may then select which of the prediction models are to be included in the stacked prediction model.

In certain embodiments, a weighting factor is assigned to each prediction model that is to be included in the stacked at operation 410. In certain embodiments, the weight assigned to each prediction model corresponds to the inverse value of the error of the respective prediction model. In certain embodiments, the inverse value of the error may be determined as:

$$\frac{1}{{Error}_{Model}} * Model$$

where Error_{Model} is the error associated with prediction model.

At operation 412, certain embodiments generate the stacked prediction model using the selected prediction models and their corresponding weighting factors. As an example, the stacked prediction model may be expressed as:

$$\frac{( \begin{matrix}{Forecast}_{1} \times \frac{1}{{Error}_{M o d e l 1}} + {Forecast}_{2} \times \frac{1}{{Error}_{M o d e l 2}} + \\ {Forecast}_{3} \times \frac{1}{{Error}_{M o d e l 3}} + … + {Forecast}_{n} \times \frac{1}{{Error}_{M o d e l n}}\end{matrix} )}{( \frac{1}{{Error}_{M o d e l 1}} + \frac{1}{{Error}_{M o d e l 2}} + \frac{1}{{Error}_{M o d e l 3}} + … + \frac{1}{{Error}_{M o d e l n}} )}$$

$$where$$

$${Model}_{1} through {Model}_{n} = the multiple prediction models used in the stacked prediction model ;$$

$${Forecast}_{1} through {Forecast}_{n} = values forecast using respective models {Model}_{1} through {Model}^{n} ; and$$

$${Error}_{Model 1} through {Error}_{Model n} = an error respectively associated with {Model}_{1} through {Model}_{n} .$$

Extending this example to exemplary embodiments employing MAPE, the stacked prediction model may be expressed as:

$$\frac{( \begin{matrix}{Forecast}_{1} \times \frac{1}{{MAPE}_{M o d e l 1}} + {Forecast}_{2} \times \frac{1}{{MAPE}_{M o d e l 2}} + \\ {Forecast}_{3} \times \frac{1}{{MAPE}_{M o d e l 3}} + … + {Forecast}_{n} \times \frac{1}{{MAPE}_{M o d e l n}}\end{matrix} )}{( \begin{matrix}\frac{1}{{MAPE}_{M o d e l 1}} + \frac{1}{{MAPE}_{M o d e l 2}} + \frac{1}{{MAPE}_{M o d e l 3}} + … + \\ \frac{1}{{MAPE}_{M o d e l n}}\end{matrix} )}$$

$$where$$

$${Model}_{1} through {Model}_{n} = the multiple prediction models used in the stacked prediction model ;$$

$${Forecast}_{1} through {Forecast}_{n} = values forecast using respective models {Model}_{1} through {Model}_{n} ; and$$

$${MAPE}_{Model 1} through {MAPE}_{Model n} = the MAPE respectively associated with {Model}_{1} through {Model}_{n} .$$

Once the stacked prediction model has been generated, it may be incorporated into a market forecasting system to generate one or more market forecasts at operation 414. In certain embodiments, the market forecasts may relate to a volume of sales of one or more products. In certain embodiments, the market forecasts may relate to the amount of services provided by one or more organizations. In certain embodiments, a user may select a variable of interest (e.g., sales, services, etc.) and provide a forecast for that variable of interest against a predictor (e.g., time of year, sales promotions, holidays, etc.). It will be recognized, in view of the teachings of the present disclosure, that such a stacked prediction model may be used to make a variety of different types of market forecasts.

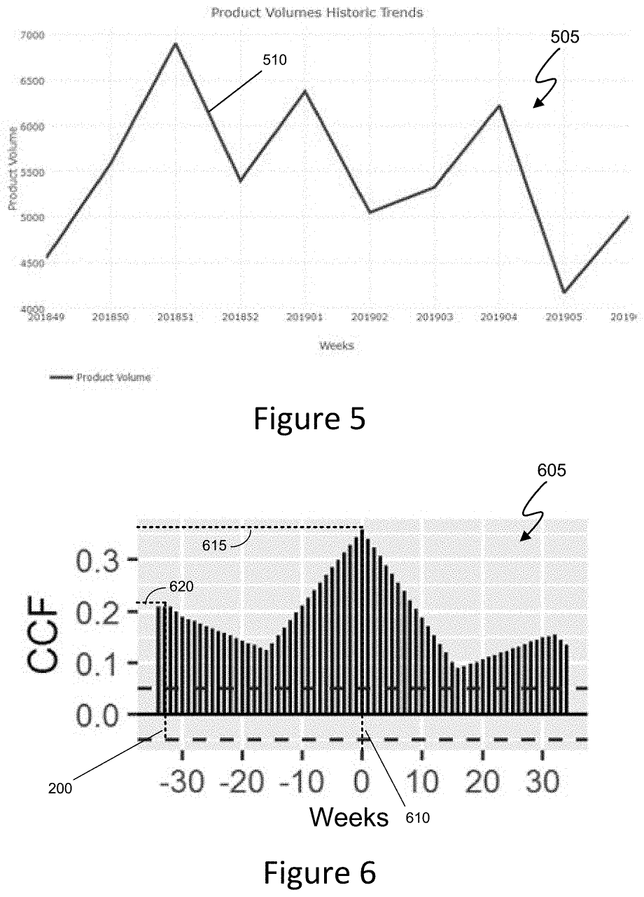

FIG. 5 is a graph 505 showing one example of time-series sequence data 510 that may be consumed by the stacked prediction model generator 124 to generate a stacked prediction model. In this example, the historic trend of the sales of a product, shown here as product volume, is plotted as a function of time. Certain embodiments may obtain the time-series sequence data from in-house data, data provided by third parties, and/or a combination of data from multiple data sources.

In certain embodiments, the time-series sequence data 510 may be analyzed against certain predictors by cross-correlating a time-series sequence data for the predictor with the time-series sequence data 510 of a variable of interest. FIG. 6 is a graph 605 showing one example of such a correlation. In this example, a cross-correlation factor for a predictor (e.g., holiday, sales of other products, etc.) is calculated with respect to a volume of sales of a product. In this specific example, the time-series sequence data for the predictor has been correlated with the product sales volume based on their timed relationship, shown here on the horizontal axis as weeks. In this example, the highest correlation between the predictor and the variable of interest occurs at week zero, shown at line 610, with a correlation factor of approximately 0.35, shown at line 615. As such, in this example, the greatest cross-correlation between the selected predictor and the volume of sales of the product occur at the same time. However, as shown in this example, another peak correlation factor of 0.21, shown at line 620, occurs at thirty-two weeks prior to week 0, thereby indicating that there may be a trend occurring between the volume of sales and the predictor thirty-two weeks before the point of highest correlation. In certain embodiments, the cross-correlation factors between the predictor and variable of interest may be considered when forecasting market behavior.

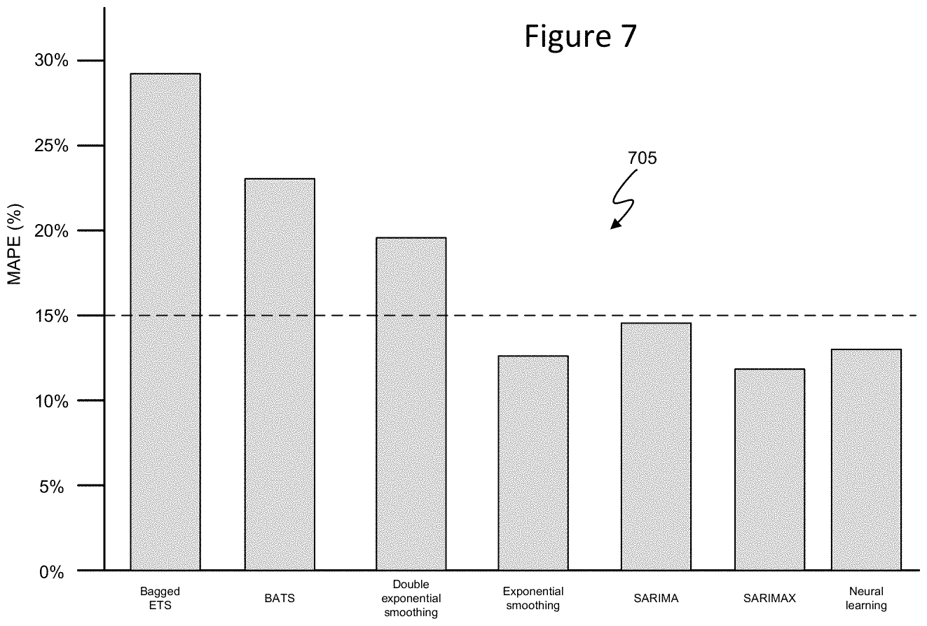

FIG. 7 is a chart 705 showing examples of errors that may be associated with different prediction models in certain embodiments of the disclosed system. In certain embodiments, the chart 705 may be presented at an interface to allow a user to manually select which prediction models are to be included in the stacked prediction model. It will be recognized, in view of the teachings of the present disclosure, that the information shown in chart 705 may be presented in a number of different manners, the illustrated chart merely being one, non-limiting example.

In certain embodiments, a user may select a predetermined error threshold for accepting a prediction model for inclusion in the stacked prediction model. In certain embodiments, the predetermined error threshold may be a parameter that is built into the stacked prediction model generator 124. In certain embodiments in which the user manually selects which prediction models are to be used in the stacked prediction model, the user may be shown the predetermined error threshold and its relationship to the errors associated with the various prediction models. In certain embodiments, the stacked prediction model generator 124 automatically selects only those prediction models having errors below the predetermined error threshold for inclusion in the stacked prediction model.

In the example depicted in FIG. 7, the errors associated with each prediction model are shown as MAPE values. Also, the maximum predetermined threshold error that is to be used to determine which of the prediction models are included in the stacked prediction model is shown in this example as 15%. In this example, the errors respectively associated with the Bagged ETS, BATS, and double exponential smoothing prediction models exceed the predetermined threshold error and should not be included in the prediction model based on the 15% threshold. In this example, the errors associated with the exponential smoothing, SARIMA, SARIMAX, and neural learning models fall below the predetermined 15% threshold value and, therefore, may be included in the stacked prediction model of this embodiment.

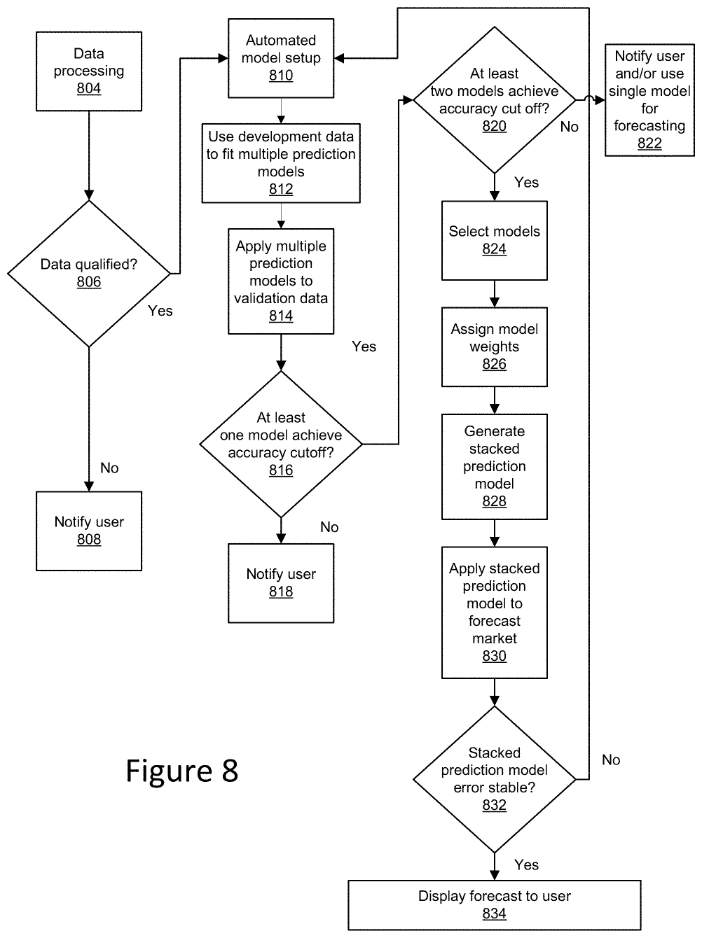

FIG. 8 is a flowchart depicting operations that may be executed in certain embodiments of the market forecast system 118. In certain embodiments, raw data is received and subject to data processing at operation 802 to provide the time-series sequence data that will be used in subsequent operations. In certain embodiments, data processing may include organizing the raw data and indexing the raw data by a time of interest, a time-dependent series of predictors, etc. In certain embodiments, data processing may involve identifying missing data points, missing time series, etc.

In certain embodiments, a determination may be made at operation 806 as to whether the time-series sequenced data meets the criterion necessary for use in prediction modeling. In certain embodiments, the time-series sequenced data is analyzed to determine whether the time-series sequenced data has sufficient data points to generate a model, missing time-series points that prohibit the generation of a model having a desire degree of accuracy, etc. If the sufficiency criterion analysis indicates that the time-series sequenced data is not qualified for further use in model development, the user may be notified of this condition at operation 808.

If the data is qualified at operation 808, the system may proceed to initiate an automated set up of the model at operation 810. In certain embodiments, the time-series sequence data may be split into two sets—development and validation. Certain embodiments may use an 80-20 split of the time-series sequence data in this operation. In certain embodiments, data splitting may also take place with the influential factors mapped to the same time stamp as the variable of interest for which forecast is needed. In certain embodiments, the system may display a run chart, such as the chart shown in FIG. 5, and the relationship between the variable of interest and a predictor (e.g. the influential factors overtime) such as shown in the chart of FIG. 6.

In certain embodiments, the set of development time-series sequence data is fit to multiple prediction models at operation 812. In certain embodiments, the development data is used by individual prediction models to generate various parameters that tune the prediction models so that they exhibit optimal behavior on the development data. In certain embodiments, the validation data is then applied to the multiple prediction models at operation 814 to determine the error respectively associated with each of the prediction models. In certain embodiments, a determination is made at operation 816 as to whether at least one model achieves the accuracy cutoff (e.g., predetermined error threshold), as described herein. If there are no models that achieve the accuracy cutoff, certain embodiments notify the user of this determination at operation 818, at which point the user may elect to employ a different set of different prediction models at operation 812 or choose another manner of making a market forecast.

If at least one model achieves the accuracy cutoff, certain embodiments may make a determination at operation 820 as to whether at least two prediction models achieve the accuracy cutoff. If only a single model meets the accuracy cutoff, the user may be notified of this condition at operation 822, at which point the user may elect to use the single prediction model in making the market forecast without generating a stacked prediction model. In certain embodiments, the user may manually elect to use the single prediction model, while in other embodiments the system may automatically employ the single prediction model in making market forecast.

In certain embodiments, the prediction models that are to be used to generate the stacked prediction model are selected at operation 824, as described herein. In certain embodiments, the weights that are to be assigned to each prediction model in the stacked prediction model are determined and assigned at operation 826, as described herein. In certain embodiments, the prediction models, with their respectively assigned weights, are used at operation 828 generate the stacked prediction model. At operation 830, certain embodiments apply the stacked prediction model in the market forecast system to forecast market behavior based, for example, on the queries provided by the user.

Certain embodiments may monitor whether the stacked prediction model is stable over time. In certain embodiments, realized historical data obtained since a prior market forecast may be used to validate the stacked prediction model. In certain embodiments, if the error resulting from application of the stacked prediction model exceeds a predetermined threshold to the realized historical data, the system may proceed to operation 810 in order to begin operations that lead to the generation of a new stacked prediction model. In certain embodiments, if it is the first time that the stacked prediction model has been used in a market forecast, the forecast may be displayed to the user at operation 834. Further, if a determination is made at operation 832 that the stacked prediction model is stable, the forecast may likewise be displayed to the user at operation 834 in certain embodiments.

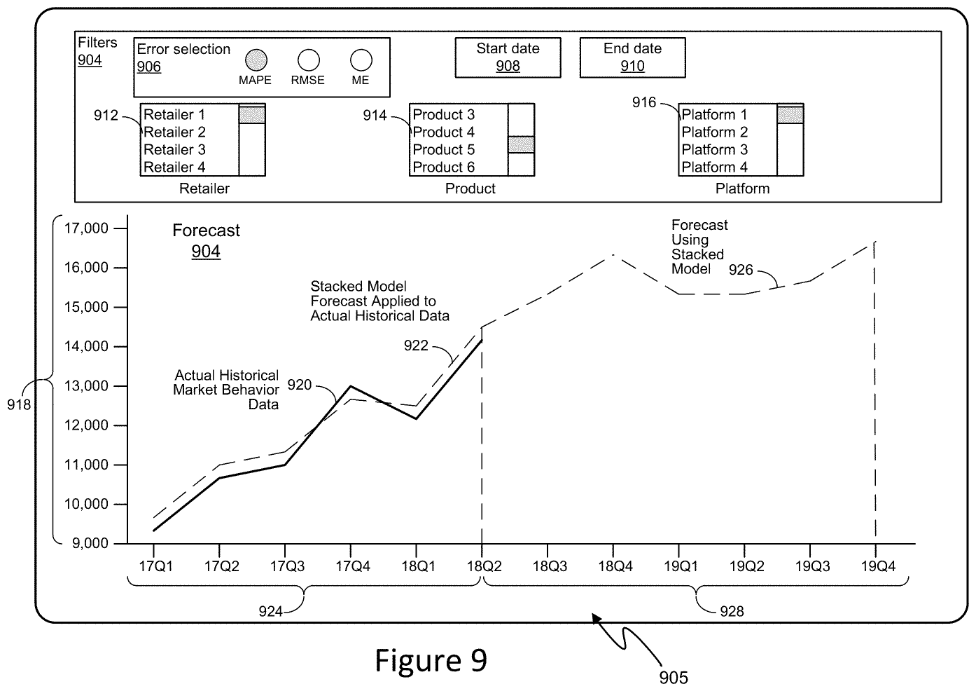

FIG. 9 depicts one example of a user interface 902 that may be implemented in certain embodiments of the disclosed system. In this example, the user interface 902 includes a filter region 904, which may be used to select the criterion that are to be used in the market forecast and/or stacked prediction model generation. In certain embodiments, the filter region 904 includes an error selection region 906, which may be used to select the type of error algorithm that is to be applied to generate the stacked prediction model. In certain embodiments, the filter region 906 includes a start date field 908 and end date field 910, which allow the user to enter the start date and end date for the market forecast. In certain embodiments, the filter region 904 includes a retailer list field 912, which allows the user to select one or more retailers that are to be included in the market forecast. In certain embodiments, the filter region 904 includes a product list field 914, which allows the user to select one or more products that are to be included in the market forecast. In certain embodiments, the filter region 904 includes an additional field, such as a platform field 916 (e.g., operating system type of the server, etc.), which may be used as a further criterion the generation of the market forecast.

In certain embodiments, the forecast region 904 displays information relating to the market forecast. In certain embodiments, a volume of product 918 is displayed as a function of time. In certain embodiments, the forecast region 904 may display actual historical market behavior data 920 and the stacked prediction model forecast as applied to the actual historical data 922 for a historical time period 924. In certain situations, the display of the actual historical market behavior data with the stacked prediction model applied to the actual historical data may allow a user to assess the accuracy of the currently employed stacked prediction model.

In certain embodiments, the forecast region 904 also displays a market forecast 926 using the current stacked prediction model. In the example shown in FIG. 9, the market forecast 926 is shown over a future time period 928 entered, for example, in the start date field 908 and end date field 910.

It will be recognized by those skilled in the art, in view of the teachings herein, that the user interface may be implemented in various manners. Consequently, the example shown in FIG. 9 is merely exemplary and should not be construed to impose any limitations on the user interface as that may be employed with certain embodiments of the present invention.

As will be appreciated by one skilled in the art, the present invention may be embodied as a method, system, or computer program product. Accordingly, embodiments of the invention may be implemented in hardware, in software (including firmware, resident software, micro-code, etc.) or in an embodiment combining software and hardware. Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implemented method for forecasting market behavior comprising:
accessing stored time-series sequenced data representing historical market behavior;
applying multiple prediction models to the time-series sequenced data;
determining a respective error associated with application of each multiple prediction model to the time-series sequenced data;
generating a stacked prediction model using at least two of the multiple prediction models, wherein the stacked prediction model includes a weighting factor for each of the prediction models used in the stacked prediction model, wherein the weighting factor for each of the prediction models in the stacked prediction model employs an inversion of the respective error in the prediction model; and
applying the stacked prediction model to forecast market behavior.

2. The computer-implemented method of claim 1, wherein
the stacked prediction model includes a weighting relationship comprising:
$$\frac{( \begin{matrix}{Forecast}_{1} \times \frac{1}{{Error}_{M o d e l 1}} + {Forecast}_{2} \times \frac{1}{{Error}_{M o d e l 2}} + \\ {Forecast}_{3} \times \frac{1}{{Error}_{M o d e l 3}} + … + {Forecast}_{n} \times \frac{1}{{Error}_{M o d e l n}}\end{matrix} )}{( \frac{1}{{Error}_{M o d e l 1}} + \frac{1}{{Error}_{M o d e l 2}} + \frac{1}{{Error}_{M o d e l 3}} + … + \frac{1}{{Error}_{M o d e l n}} )}$$
$$where$$
$${Model}_{1} through {Model}_{n} = the multiple prediction models used in the stacked prediction model ;$$
$${Forecast}_{1} through {Forecast}_{n} = values forecast using respective models Model1 through Modeln ; and$$
$${Error}_{Model 1} through {Error}_{Model n} = an error value respectively associated with {Model}_{1} through {Model}_{n} .$$

3. The computer-implemented method of claim 2, wherein
the one or more of the error values, Error_{Model1} through Error_{Modeln}, includes a mean absolute percentage error (MAPE) respectively associated with models Model₁ through Modelₙ.

4. The computer-implemented method of claim 1, wherein
the multiple prediction models include one or more of a SARIMA model, SARIMAX model, a neural net model, a state space model, an exponential smoothing model, a double exponential smoothing model, a shallow learning model, and bootstrap aggregating model.

5. The computer-implemented method of claim 1, further comprising:
selecting whether a prediction model is to be used in the stacked prediction model based on the error associated with the prediction model, wherein a prediction model is only included in the stacked prediction model if the error meets a predetermined criterion.

6. The computer-implemented method of claim 1, wherein
the time-series sequenced data is cross-correlated with a predictor, and wherein a resulting cross-correlation function is incorporated either directly in the stacked prediction model, or indirectly through at least one of the multiple models incorporated in the stacked prediction model.

7. The computer-implemented method of claim 1, further comprising:
applying the stacked prediction model to forecast market behavior over a time frame;
comparing the forecasted market behavior over the time frame with realized data occurring over the time frame to determine an error factor for the stacked prediction model as applied over the time frame; and
automatically generating a new stacked prediction model using the realized data occurring over the timeframe if the error factor is greater than a minimum threshold.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
accessing stored time-series sequenced data representing historical market behavior;
applying multiple prediction models to the time-series sequenced data;
determining a respective error associated with application of each multiple prediction model to the time-series sequenced data;
generating a stacked prediction model using at least two of the multiple prediction models, wherein the stacked prediction model includes a weighting factor for each of the prediction models used in the stacked prediction model, wherein the weighting factor for each of the prediction models in the stacked prediction model employs an inversion of the respective error in the prediction model; and
applying the stacked prediction model to forecast market behavior.

9. The system of claim 8, wherein
the stacked prediction model includes a weighting relationship comprising:
$$\frac{( \begin{matrix}{Forecast}_{1} \times \frac{1}{{Error}_{M o d e l 1}} + {Forecast}_{2} \times \frac{1}{{Error}_{M o d e l 2}} + \\ {Forecast}_{3} \times \frac{1}{{Error}_{M o d e l 3}} + … + {Forecast}_{n} \times \frac{1}{{Error}_{M o d e l n}}\end{matrix} )}{( \frac{1}{{Error}_{M o d e l 1}} + \frac{1}{{Error}_{M o d e l 2}} + \frac{1}{{Error}_{M o d e l 3}} + … + \frac{1}{{Error}_{M o d e l n}} )}$$
$$where$$
$${Model}_{1} through {Model}_{n} = the multiple prediction models used in the stacked prediction model ;$$
$${Forecast}_{1} through {Forecast}_{n} = values forecast using respective models Model1 through Modeln ; and$$
$${Error}_{Model 1} through {Error}_{Model n} = an error value respectively associated with {Model}_{1} through {Model}_{n} .$$

10. The system of claim 9, wherein
the one or more of the error values, Error_{Model1} through Error_{Modeln}, includes a mean absolute percentage error (MAPE) respectively associated with models Model₁ through Modelₙ.

11. The system of claim 8, wherein
the multiple prediction models include one or more of a SARIMA model, SARIMAX model, a neural net model, a state space model, an exponential smoothing model, a double exponential smoothing model, a shallow learning model, and bootstrap aggregating model.

12. The system of claim 8, wherein the instructions are further configured for:
selecting whether a prediction model is to be used in the stacked prediction model based on the error associated with the prediction model, wherein a prediction model is only included in the stacked prediction model if the error meets a predetermined criterion.

13. The system of claim 8, wherein
the time-series sequenced data is cross-correlated with a predictor, and wherein a resulting cross-correlation function is incorporated either directly in the stacked prediction model, or indirectly through at least one of the multiple models incorporated in the stacked prediction model.

14. The system of claim 8, wherein the instructions are further configured for:
applying the stacked prediction model to forecast market behavior over a time frame;
comparing the forecasted market behavior over the time frame with realized data occurring over the time frame to determine an error factor for the stacked prediction model as applied over the time frame; and
automatically generating a new stacked prediction model using the realized data occurring over the timeframe if the error factor is greater than a minimum threshold.

15. A non-transitory, computer-readable storage medium embodying computer program code, the computer program code comprising computer executable instructions configured for:
accessing stored time-series sequenced data representing historical market behavior;
applying multiple prediction models to the time-series sequenced data;
determining a respective error associated with application of each multiple prediction model to the time-series sequenced data;
generating a stacked prediction model using at least two of the multiple prediction models, wherein the stacked prediction model includes a weighting factor for each of the prediction models used in the stacked prediction model, wherein the weighting factor for each of the prediction models in the stacked prediction model employs an inversion of the respective error in the prediction model; and
applying the stacked prediction model to forecast market behavior.

16. The non-transitory, computer-readable storage medium of claim 15, wherein
the stacked prediction model includes a weighting relationship comprising:
$$\frac{( \begin{matrix}{Forecast}_{1} \times \frac{1}{{Error}_{M o d e l 1}} + {Forecast}_{2} \times \frac{1}{{Error}_{M o d e l 2}} + \\ {Forecast}_{3} \times \frac{1}{{Error}_{M o d e l 3}} + … + {Forecast}_{n} \times \frac{1}{{Error}_{M o d e l n}}\end{matrix} )}{( \frac{1}{{Error}_{M o d e l 1}} + \frac{1}{{Error}_{M o d e l 2}} + \frac{1}{{Error}_{M o d e l 3}} + … + \frac{1}{{Error}_{M o d e l n}} )}$$
$$where$$
$${Model}_{1} through {Model}_{n} = the multiple prediction models used in the stacked prediction model ;$$
$${Forecast}_{1} through {Forecast}_{n} = values forecast using respective models Model1 through Modeln ; and$$
$${Error}_{Model 1} through {Error}_{Model n} = an error value respectively associated with {Model}_{1} through {Model}_{n} .$$

17. The non-transitory, computer-readable storage medium of claim 16, wherein
the one or more of the error values, Error_{Model1} through Error_{Modeln}, includes a mean absolute percentage error (MAPE) respectively associated with models Model₁ through Modelₙ.

18. The non-transitory, computer-readable storage medium of claim 15, wherein
the multiple prediction models include one or more of a SARIMA model, SARIMAX model, a neural net model, a state space model, an exponential smoothing model, a double exponential smoothing model, a shallow learning model, and bootstrap aggregating model.

19. The non-transitory, computer-readable storage medium of claim 15, wherein the instructions are further configured for:
selecting whether a prediction model is to be used in the stacked prediction model based on the error associated with the prediction model, wherein a prediction model is only included in the stacked prediction model if the error meets a predetermined criterion.

20. The non-transitory, computer-readable storage medium of claim 15, wherein the instructions are further configured for:
applying the stacked prediction model to forecast market behavior over a time frame;
comparing the forecasted market behavior over the time frame with realized data occurring over the time frame to determine an error factor for the stacked prediction model as applied over the time frame; and
automatically generating a new stacked prediction model using the realized data occurring over the timeframe if the error factor is greater than a minimum threshold.
